(19) United States
(12) Patent Application Publication
(10) Pub. No.: US 2004/0010589 A1
(43) Pub. Date: Jan. 15, 2004

(54) Method to generate and manipulate visitor traffic to on-line and off-line business sites

(76) Inventor: Donald M. Keenan, Wexford, PA (US)

Correspondence Address: Cohen & Grigsby, P.C., 15th Floor, 11 Stanwix Street, Pittsburgh, PA, 15222, US

(21) Appl. No.: 10/610,480

(22) Filed: Jun. 30, 2003

Related U.S. Application Data
(60) Provisional application No. 60/394,819, filed on Jul. 11, 2002.

(51) Int. Cl. G06F 15/173

(52) U.S. Cl. 709/224

(57) ABSTRACT

The invention is a method to generate and manipulate visitor traffic at a computer network site, and to direct the generated traffic to off-line business sites. The invention provides a site accessible to a visitor. The invention communicates to said visitor that there is an availability of compensation. That availability of compensation is associated with the visitor's access or presence the site. An adjustable lead period is provided, wherein said adjustable lead period comprises a requirement. The invention involves initiating said adjustable lead period and indicating to said visitor that the adjustable lead period has been initiated and a relative progress of said adjustable lead period.

### CROSS REFERENCE

This application claims priority to U.S. Provisional Patent Application No. 60/394,819 filed Jul. 11, 2002, the disclosure of which is incorporated by reference herein.

### FIELD OF THE INVENTION

The invention is directed toward interactive methods of conducting on-line and off-line business. More specifically, the invention relates to methods of generating and manipulating on-line visitor traffic at computer network sites, and directing those on-line visitors to off-line business sites. The method is also a way to obtain on-line visitor information that can be used to direct target messages to those on-line visitors.

### BACKGROUND OF THE INVENTION

The Internet and e-commerce have had a significant impact on the business world. The most recently released numbers are impressive and predict ongoing growth. Despite these predictions of growth, many Internet businesses are failing. The model for a successful long-term Internet business has yet to be identified. The Internet's greatest utility may simply be as a medium to access potential customers for a business's off-line site. It follows then that new ideas to attract and retain visitor traffic on the computer network site would be valuable. Encouraging these visitors to then travel to an off-line business is also valuable. This method may further help to define the true commercial value of a computer network such as the Internet.

### BRIEF DESCRIPTION OF THE DRAWINGS

FIG. 1 is a flow diagram of an embodiment of the invention.

FIG. 2 is a detailed depiction of the operation of the lead period in an embodiment of the invention.

### SUMMARY OF THE INVENTION

The invention is a method to generate and manipulate visitor traffic at a computer network site, and to direct the generated traffic to off-line business sites. The invention provides a site accessible to a visitor. The invention communicates to said visitor that there is an availability of compensation. That availability of compensation is associated with the visitor's access or presence at the site. An adjustable lead period is provided, wherein said adjustable lead period comprises a requirement. The invention involves initiating said adjustable lead period and indicating to said visitor that the adjustable lead period has been initiated and a relative progress of said adjustable lead period. This step of indicating can be done by way of a graphical representation. The invention involves initiating an availability period if said requirement of said lead period is met. The availability period comprises indicating to said at least one visitor information sufficient to enable the visitor to obtain the compensation, for example by directing the visitor to make a phone call, send an electronic mail, visit another network site, or visit an off-line merchant to obtain compensation. The method also provides for obtaining information about the visitor and using that information to direct targeted messages to said visitor thereby provide a useful tool for business and advertisers that desire to create a focused marketing or advertising campaign

The method is a novel way to address a long felt need which is to encourage visitors to make repeat visits to a computer network site, to encourage the same visitor to become intensely focused on the site and prolong their stay at the site, and to encourage these visitors to travel to an off-line business as potential customers. In addition to the manipulation of traffic at the computer network site, the method also gathers and distributes targeted information to select visitors based on preferences.

### DESCRIPTION OF A PREFERRED EMBODIMENT

The invention was devised as a method to manipulate on-line visitor traffic at a computer network site and then forward that traffic to off-line businesses. A visitor is any person or entity that opens, accesses, views, or otherwise perceives a site on any network, including but not limited, to the Internet, or the World Wide Web. A core component of the method is an adjustable lead period, that may be graphically represented, at a computer network site. The process provides motivation that ultimately encourages visitors to go to the off-line place of business. Said motivation relates to an incentive or compensation that is provided to some visitors to the site. Information that allows a visitor to obtain the compensation is made available at the computer network site only during an award phase. The award phase comprises a lead period followed by an availability period. The duration or parameters of the lead period may be unknown to the visitor, and in the preferred embodiment, the duration or parameters are unknown. A graphical representation of time may be present at the computer network site during the lead period to alert visitors as to when the availability period may occur (which in a preferred embodiment, is at the same point the lead period ends). It is anticipated that a visitor would be intensely focused on the site during this lead period as the visitor waited for the availability period to begin. During the availability period, the visitor is then provided with the information necessary to collect the compensation.

The computer network site may be an Internet site on the World Wide Web or a site on an Intranet or any other computer network. The network site may be accessed by conventional technologies including, but not limited to, personal or lap top computers, hand held devices, kiosks, or other related technologies. The skilled artisan will appreciate that access to the computer network site may be provided at any location where the technologies can be accessed.

The availability of compensation is communicated to the visitor. Compensation is defined as any incentive that will encourage visitors to the computer network site to participate in the process. The compensation may be a monetary prize, free merchandise, discounts at retail or wholesale establishments, or any other item, privilege, or discount that can be considered to encourage participation in the process. The information necessary for a visitor to collect each item of compensation is provided to the visitor during the availability period for that particular item of compensation. In that some forms of compensation may need to be claimed at an off-line business, one embodiment of the method allows for compensation to be listed in a geographically restricted manor utilizing ZIP codes or similar methodologies so that visits to the off-line merchant are practical.

An on-line visitor who browses the computer network site can assess whether or not there is any compensation in which he or she is interested. If interested in participating, one embodiment of the method requires the visitor to register at the hosting site by providing visitor information, which is demographic, preference, and other contact information. The visitor may or may not be told exactly when the award phase for any particular compensation will occur although the visitor may be provided with an estimated time. In this regard, an object of the method is to entice the visitor to make frequent visits to the computer network site in an attempt to be present at the site during the award phase. In an embodiment, the visitor information provided when the visitor registers may be used to provide an interested person with estimations as to when the award phase will begin or, in situations where the award phase has already begun, to inform them that the award phase has actually begun. In the preferred embodiment where the duration or parameters of the adjustable lead period are unknown, the method may provide the visitor with bonus information regarding the said timing or parameters based on the visitor registering and providing a selected amount of visitor information. In this way, visitors would be encouraged to provide visitor information which ultimately can be used by a business to aid it in a focused marketing campaign directed at said visitor. Visitors would collect the bonus information via a plurality of methods including, but not limited to, arrangements with off-line businesses whereby visitors are rewarded for their patronage, or by the business providing the bonus information at an off-line site.

The award phase is comprised of an adjustable lead period. A lead period is comprised of at least one requirement. In a preferred embodiment, the requirement is simply the passage of an adjustable predetermined amount of time. Preferably, the visitor is not made aware of how long this lead period will last, or what requirements need to be fulfilled to end the lead period. In other embodiments, the visitor may be made aware of how long the lead in period will last, or what requirements need to be fulfilled to end the lead period. Visitors are made aware that following the lead period there is an availability period during which the visitor is provided with the information necessary to obtain the compensation. As explained above with reference to bonus information, the visitor may be provided with estimates as to when the lead period will begin, the duration of the lead period, or when the availability period will occur. This informing of the visitor is done if the visitor provides a predetermined amount of visitor information, or if the visitor meets the criteria for bonus information. The actual requirements that need to be fulfilled in order to trigger the availability period, or the actual duration of the lead period is not necessarily constant and may be adjusted while it is occurring in an attempt to manipulate visitor presence and interest at the computer network site. During the lead period, there may be a graphical representation of the progress of the lead period. This graphical representation may occur in any form that will depict the passage of time toward a visible or implied endpoint, or progress from a beginning point to an end point. Some examples would include a fuse, an hourglass, and an alarm clock. The graphically represented lead period allows the visitor to see that the availability period is nearing, and in doing so, the invention accomplishes its object which is to intensely focus the visitor on the site during this lead period. The graphical representation serves several purposes. First, it alerts visitors to the computer network site that an award phase has begun and compensation will be distributed in the near future. Second, as the graphical representation nears an end, it encourages the visitor's presence and interest in the computer network site because the visitor will anticipate the availability period. Thus, the method allows one to: a) identify time periods during which there will be a characterized group of visitors at a computer network site, b) manipulate when and for how long these periods will occur, c) allow one to collect data from the visitors, d) deliver targeted messages to those present at the computer network site based on the visitor information provided in the registration embodiment of the invention, and e) drive visitors at the computer network site to an off-line point of sale.

The second component in the award phase is the availability period. The visitor information may be utilized to alert those not present at the computer network site that the availability period has begun. During the availability period the visitor is provided with information necessary to claim the compensation. An example of the types of methods that may be used to provide the visitor with the information necessary to claim the compensation include requesting the visitor to place a phone call or send an e-mail. Alternatively, the visitor may be required to visit another computer network site or an off-line merchant to claim the compensation. In the case where there are more visitors who have obtained the necessary information to collect a particular compensation than there is available compensation, then secondary factors may be utilized to allow a visitor to claim compensation. For example, in a situation where more than one visitor is requested to place a phone call to claim his or her compensation, a secondary factor may include a merchant defined parameter that selects the fifth caller to compensate.

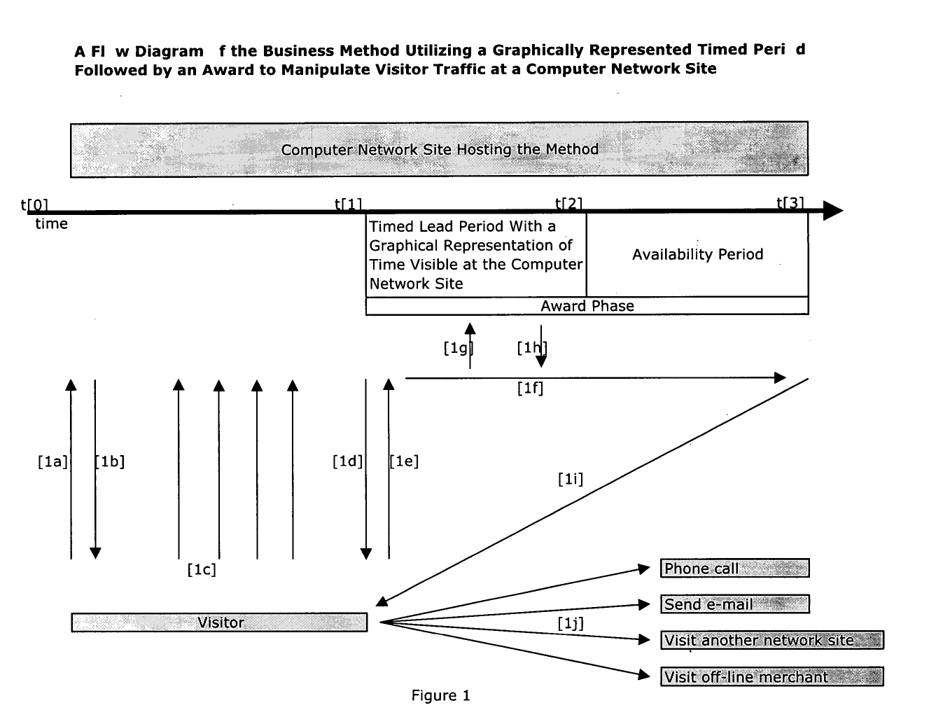

FIG. 1 is a flow diagram of an embodiment the method. In this embodiment, the large arrow oriented left to right represents time. The method is based at a computer network host site. Also shown in the diagram is a hypothetical visitor to the hosting site as well as an off-line merchant and a secondary computer network site. The process begins with a visitor becoming aware of the process and visiting the site [1a] at time t[0]. While at the site, the visitor is given a full description of the process and a list of the available compensation [1b]. At this point the visitor has identified a specific compensation in which he/she has interest in obtaining. One embodiment of the method requires that the visitor provide visitor information, i.e., demographic, preference, and contact information, during a registration to be eligible to claim the compensation. While at the site the visitor is informed that the information necessary to obtain the compensation will be made available at the site during the award phase. A temporal representation of the award phase is shown in FIG. 1 at (t[1]-t[3]). In this embodiment, the visitor is not given information as to exactly when the award phase will occur although they may be given some estimation. The objective of the method then is to entice the visitor to then make frequent visits to the site in an attempt to be present for the award phase [1c]. The registration embodiment of the method allows the visitor to be contacted with estimates as to when the award phase may take place [1d]. Alternatively, a notice may be sent that coincides with the activation of the award phase as shown in the diagram. The visitor is now at the site as the award phase begins at t[1] as represented by [1e]. It is not essential, however, that the visitor be present when the award phase begins. The first component of the award phase is the lead period, temporally represented by t[1]-t[2]. During this period, a graphical representation is provided. That representation then indicates to the visitor that he or she is nearing the end of the lead period, which coincides with the initiation of the availability period. In the preferred embodiment, the graphical representation includes an indication of time passing toward a visible or implied endpoint. The duration of this lead period may be unknown to the visitor and may be adjusted during the process in an attempt to manipulate visitor presence and interest on-line at the computer network site. The visitor knows that at the end of this lead period they will be given information as to how to obtain the compensation during the availability period t[2]-t[3]. The visitor then becomes intensely focused at the site during the lead period while waiting for the availability period [1f]. Visitor information may be utilized to provide estimates as to the duration of the lead period. It is during this lead period, when presence and interest is anticipated to be high, that visitor information can be collected from visitors present at the site [1g]. In addition, directed messages may be sent to those visitors on-line at the computer network site based on the previously submitted visitor information, i.e., demographic, preference and contact information [1h]. In the availability period, the visitor is provided with the necessary information to obtain the compensation [1i]. Visitor information may be again utilized to alert those not currently at the computer network site that the availability period has been activated. The compensation may be claimed in a plurality of ways based on the information provided during the availability phase [1j]. The visitor may be required to place a phone call or send an e-mail to claim the compensation. Alternatively, the visitor may be required to visit another computer network site or an off-line merchant to claim the compensation.

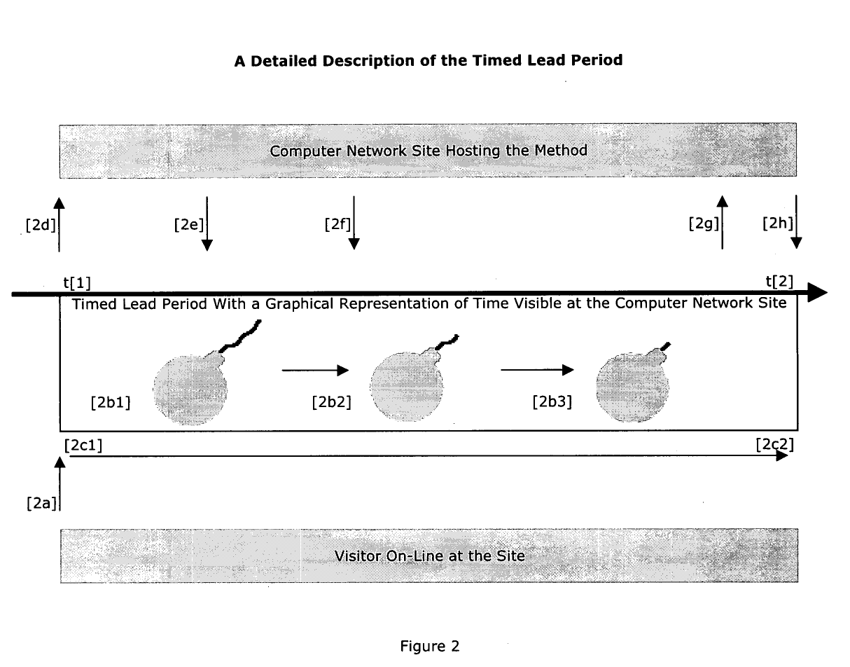

FIG. 2 demonstrates the operation of the lead period in greater detail. In this embodiment, the large arrow from left to right represents time. The lead period activates at t[1] and ends at t[2] at which point the availability period of the award phase is initiated. Upon initiation of the availability period, visitors are provided with information that would allow them to claim a specific item of compensation, such as a phone number to call or that address of a business to which they must go. The hosting computer network site is shown above the time arrow and an on-line visitor to the hosting computer network site is shown below the time arrow. The duration of the lead period is not necessarily constant and can be manipulated by the computer network site hosting the method. In another embodiment, the lead period need not be based on the passage of time, but rather it could be based upon the visitor fulfilling predetermined requirements. For example, the lead period could be defined by the number of times a visitor accesses the site, or by the visitor providing a required amount of visitor information. Returning to FIG. 2, a visitor to the site, who has interest in obtaining a specific compensation item, is present at the site [2a]. A graphical representation of time alerts visitors that the lead period is activated. [2b1-2b3] In this example, an image of a fuse is shown however any graphical representation of time with a visible or implied endpoint may be utilized. In addition to signaling the beginning of the lead period, the graphic also imparts a sense of urgency to the visitor as he/she sees the process nearing completion. In an embodiment, the visitor is not aware of the duration of the lead period (or what requirements need to be fulfilled), however, the visitor [2c1-2c2] is motivated to obtain the compensation and thus remains as the site awaiting the end of the lead period. At the completion of the lead period the availability period activates and the visitor is provided with the information necessary to claim the compensation. The hosting computer network site collects operational .data regarding the lead period such as the number of visitor present [2d]. One embodiment of the method requires registration in advance of the lead period thus enabling the site to better characterize those on line for the lead period. Also, the registration information could be utilized to alert interested persons that the lead period has been initiated or when it may end. The site can assess the status of the process and adjust the duration of the lead period accordingly [2e]. For instance, if the site desires a greater number of visitors to be present prior to the availability phase, the duration of the lead period could be prolonged. The actual duration of the lead period remains unknown to the visitor but there would be a corresponding adjustment in the graphical representation of time to reflect that there has been a change. Alternatively, the site may have the need to end the lead period sooner than planned and thus it could be shortened with the appropriate changes being made to the time graphic. In an embodiment, the site sends directed and targeted messages to those present at the site during the lead period [2f]. The hosting site reassesses the status of the process [2g]. When the hosting site has decided that the conditions are appropriate, the lead period is ended and the availability period begins thus providing those present at the site the information necessary to collect the compensation [2h].

Accordingly, it should be readily appreciated that the above method and the uses of the present invention have many practical applications. Additionally, although the preferred embodiment has been illustrated and described, it will be obvious to those skilled in the art that various modifications can be made without departing from the spirit and scope of this invention. Such modifications are to be considered as included in the following claims unless the claims expressly recite differently.

What is claimed is:

1. A method to generate and manipulate visitor traffic at a computer network site and to direct said traffic to off-line business sites comprising the steps of:
a) providing at least one site accessible to at least one visitor;
b) communicating to said at least one visitor that there is an availability of compensation, said availability of compensation associated with said at least one visitor accessing said at least one site;
c) providing an adjustable lead period, wherein said adjustable lead period comprises at least one requirement;
d) initiating said adjustable lead period;
e) indicating to said at least one visitor
i) that said adjustable lead period has been initiated; and
ii) a relative progress of said adjustable lead period; and
f) initiating an availability period if said at least one requirement of said lead period is met, wherein said initiation of said availability period comprises indicating to said at least one visitor information sufficient to enable said at least one visitor to obtain said compensation.

2. The method of claim 1, wherein said step e) comprises graphically representing that said adjustable lead period has been initiated and said relative progress of said adjustable lead period.

3. The method of claims 1 or 2 wherein said step f) further comprises directing said at least one visitor to make a phone call, send an electronic mail, visit another network site, or visit an off-line merchant to obtain said compensation.

4. The method of claim 1, further comprising prompting said at least one visitor for visitor information and using said visitor information to direct targeted messages to said visitor.

5. The method of claim 1, wherein said at least one requirement is a passage of an adjustable amount of time.

6. The method to manipulate visitor traffic at a computer network site of claim 1, wherein said at least one requirement is said at least one visitor entering a predetermined amount of visitor information.

7. A method to generate and manipulate visitor traffic at a computer network site and to direct said traffic to off-line business sites comprising the steps of:
a) providing at least one site accessible to at least one visitor;
b) communicating to said at least one visitor that there is an availability of compensation, said availability of compensation associated with said at least one visitor accessing said at least one site;
c) providing an adjustable timed lead period having a selected duration;
d) initiating said adjustable timed lead period;
e) indicating to said at least one visitor
i) that said adjustable timed lead period has been initiated; and
ii) a relative progress of said adjustable timed lead period; and
f) initiating an availability period when said selected duration ends, wherein said initiation of said availability period comprises indicating to said at least one visitor information sufficient to enable said at least one visitor to obtain said compensation.

8. The method to manipulate visitor traffic at a computer network site of claim 7, wherein said step e) comprises graphically representing that said adjustable timed lead period has been initiated and said relative progress of said adjustable timed lead period.

9. The method to manipulate visitor traffic at a computer network site of claims 7 or 8 wherein said step f) further comprises directing said at least one visitor to make a phone call, send an electronic mail, visit another network site, or visit an off-line merchant to obtain said compensation.

10. The method to manipulate visitor traffic at a computer network site of claim 7, further comprising prompting said at least one visitor for visitor information and using said visitor information to direct targeted messages to said at least one visitor.

11. The method of claim 1 wherein said adjustable lead period is adjusted while said adjustable lead period is in progress.

12. The method of claim 2 wherein said adjustable timed lead period is adjusted during the adjustable timed lead period.

13. The method of claim 1, further comprising prompting said at least one visitor for visitor information and communicating to said at least one visitor selected information about said at least one requirement if said at least one visitor provides a predetermined amount of visitor information.

14. The method of claim 7, further comprising prompting said at least one visitor for visitor information and communicating to said at least one visitor selected information about said duration said adjustable timed lead period if said at least one visitor provides a predetermined amount of visitor information.
